(19) United States
(12) Patent Application Publication
(10) Pub. No.: US 2011/0214660 A1
(43) Pub. Date: Sep. 8, 2011

(54) SYSTEM FOR MONITORING A COOLING FAN OF AN APPLIANCE

(76) Inventors: Timothy Andrew GILLESPIE, Louisville, KY (US); Ashley Wayne Burt, Louisville, KY (US); Gregory Francis Gawron, Jeffersontown, KY (US); Gregory Owen Miller, Louisville, KY (US); Paul E. Newsom, Louisville, KY (US); Daniel Joseph Trice, Louisville, KY (US)

(21) Appl. No.: 12/719,559

(22) Filed: Mar. 8, 2010

(51) Int. Cl. F24C 15/00; F28F 13/12; H02K 11/00

(52) U.S. Cl. 126/21 A; 165/104.34; 318/490

(57) ABSTRACT

A system for monitoring a cooling fan having one or more fans blade and utilized in an appliance having a heating element. Such a system generally includes an electric switch actuated by a magnetic field of a magnet mounted on a rotary member of the cooling fan. The electric switch can be located proximate to the magnet, such that the magnet rotates past the electric switch to actuate the electric switch via the magnetic field at a switching frequency with each rotation of the rotary member. Such a system can include a circuit responsive to an electrical signal from the electric switch. The circuit can generates a signal indicative of the status of the cooling fan, based on the switching frequency of the electric switch. Such a signal can prevent overheating of the heating elements in case of a failure of the cooling fan.

### BACKGROUND OF THE INVENTION

The subject matter disclosed herein relates to monitoring an appliance to prevent overheating of the appliance.

Appliances such as cooking ranges and wall ovens are widely utilized in homes and restaurants. A cooking range typically includes an oven with a front-opening access door, and at least one heating element for heating up the inside of the oven cavity. Wall ovens have a similar configuration. As is known in the art, when energized, the heating element can heat up the inside of the oven cavity to a relatively high temperature. Also as is known in the art, such a cooking appliance often has a cooling fan which can be used to draw cooling air into the interior of the appliance to cool a structural component of the appliance, such as the front-opening access door, or a heat sensitive component such as an electronic control.

In cooking appliance such as cooking ranges equipped with cooling fans, the cooling fan must be monitored in order to prevent overheating in the event that the cooling fan fails. Prior solutions for cooling fan monitors include, for example, temperature sensors, sail switches and Hall effect sensors. Temperature sensors are calibrated such that they can detect the temperature rise associated with the cooling fan and indicate to a controller that the cooling fan has failed. Disadvantages of this method include the amount of development time required to tune sensors to the system as well as the reliance on the control software to shutdown the heating elements. Sail switches utilize a sheet metal to activate a micro-switch when moved by the airflow of the cooling fan. Disadvantages of this approach include the delicate nature of the sail switch, which can be easily bent or moved out of position and the reliance on the control software to shutdown the heating elements. A Hall effect sensor can be an effective method to determine the speed of the cooling fan speed but typically must be coupled with control software to shutdown the heating elements.

### BRIEF DESCRIPTION OF THE INVENTION

As described herein, the preferred embodiments of the present invention overcome one or more of the above or other disadvantages known in the art.

One aspect of the present invention relates to a system for monitoring a cooling fan having a rotary member and utilized in an appliance having a heating element. The system generally includes an electric switch actuated by a magnetic field of a magnet mounted on the rotary member. The electric switch is located proximate to the path of the magnet such that the magnetic field of the magnet actuates the electric switch with each rotation of the magnet past the switch, thereby causing the electric switch to switch at a switching frequency proportional to the rate of rotation of the rotary member. The system further includes a circuit responsive to an electrical signal from the electric switch. The circuit generates a signal indicative of a status of the cooling fan, based on the switching frequency of the electric switch.

Another aspect of the present invention relates to a system for monitoring a cooling fan having one or more fan blades and utilized in an appliance having a heating element. Such a system generally can include an electric switch actuated by a magnetic field of a magnet mounted on a fan blade of the cooling fan. The electric switch can be located proximate to the magnet, such that the magnet rotates past the electric switch to actuate the electric switch via the magnetic field at a switching frequency determined by the rotational speed of the fan blade. Such a system can include a circuit responsive to the switching of the electric switch. The circuit can generate a signal indicative of the status of the cooling fan, based on the switching frequency of the electric switch. Such a system can be configured to further include a controller for controlling the appliance, such that the controller can be responsive to the signal output from the circuit in order to permit the controller to directly interface with the power circuit of the appliance to disable the heating element of the appliance in the event of the failure of the cooling fan.

Yet another aspect of the present invention relates to a system for monitoring a cooling fan having one or more fan blades and utilized in an appliance having a heating element. Such a system can include a reed switch actuated by a magnetic field of a magnet mounted on the fan blade of the cooling fan. The reed switch can be located proximate to the magnet, wherein the magnet rotates past the reed switch to actuate the reed switch via the magnetic field at a switching frequency with each rotation of the fan blade. Such a system can further include a watchdog circuit responsive to the switching of the reed switch, wherein the watchdog circuit can generate a signal indicative of the status of the cooling fan, based on the switching frequency of the electric switch.

These and other aspects and advantages of the preferred embodiments of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of an exemplary cooking range incorporating a cooling fan arrangement in accordance with the disclosed embodiments;

FIG. 2 illustrates a circuit diagram depicting an embodiment of a system that includes a circuit for protecting an appliance, in accordance with an embodiment;

FIG. 3 illustrates a circuit diagram of a system that includes a circuit for monitoring an appliance, in accordance with an alternative embodiment;

FIG. 4 illustrates a three-dimensional pictorial view of the appliance depicted with respect to FIGS. 1-3 including the cooling fan and electric switch, in accordance with the disclosed embodiments;

FIG. 5 illustrates a side view of the electric switch and cooling fan depicted in FIG. 4, in accordance with the disclosed embodiments; and

FIG. 6 illustrates a schematic diagram of an alternative arrangement of the reed switch with respect to the controller, in accordance with the disclosed embodiments.

### DETAILED DESCRIPTION OF THE EXEMPLARY EMBODIMENTS OF THE INVENTION

The particular values and configurations discussed in these non-limiting examples can be varied and are cited merely to illustrate at least one of the disclosed embodiments and are not intended to limit the scope thereof.

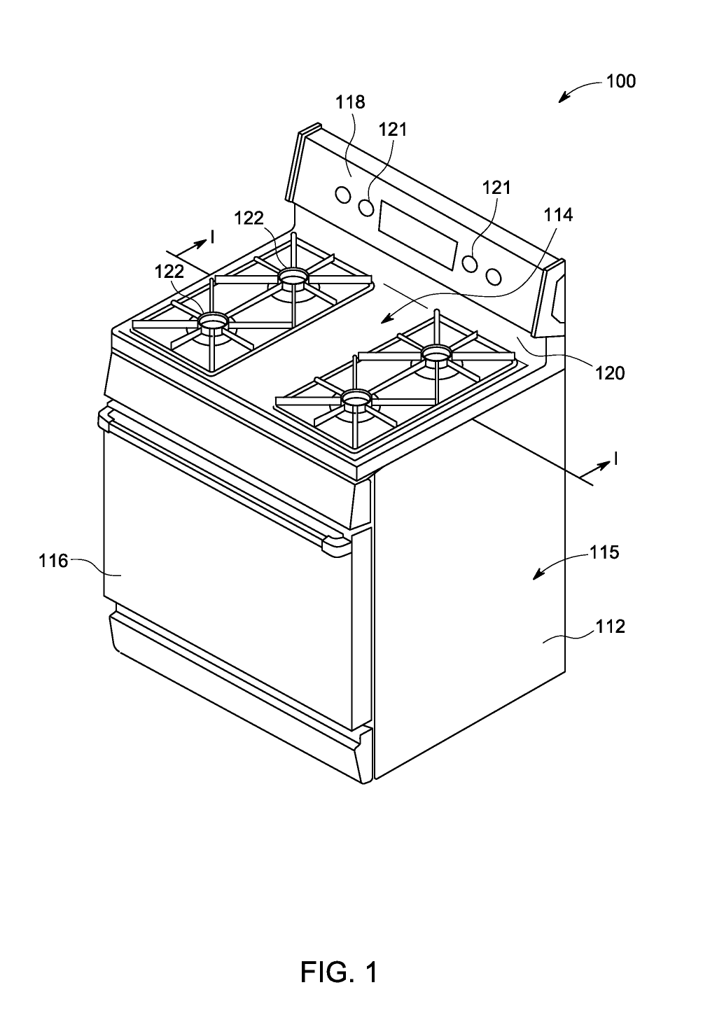

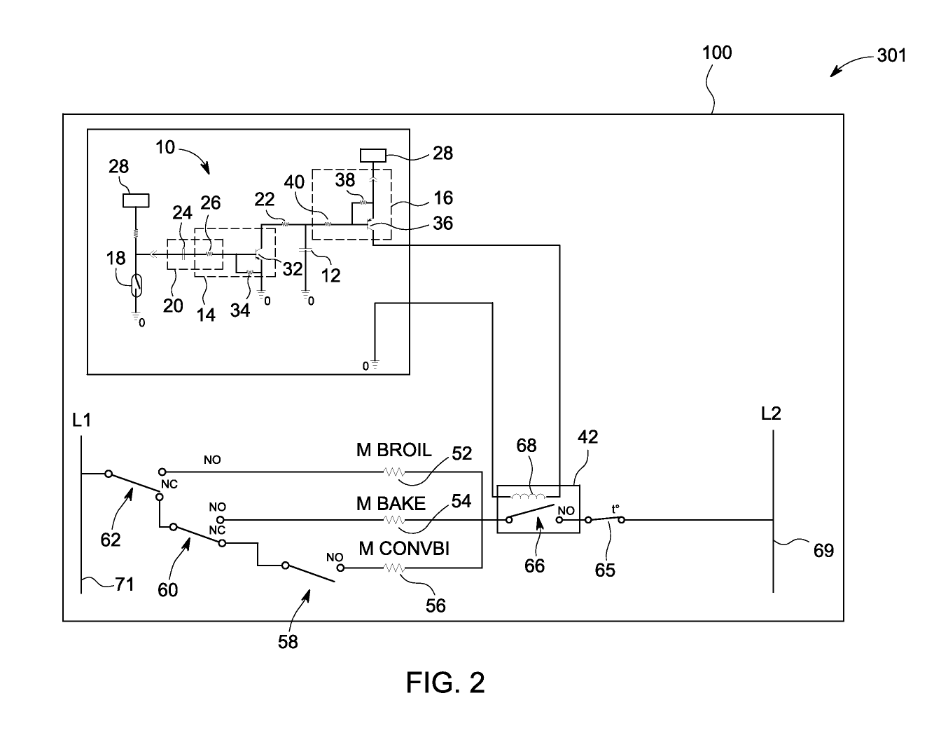

An exemplary appliance incorporating a cooling fan arrangement is generally designated by reference numeral 100 in FIGS. 1 and 2. By way of a non-limiting example, the appliance 100 is indicated in FIG. 1 as a freestanding cooking range. It can be appreciated, however, that embodiments of the present invention can also be utilized in the context of other types of appliances, such as ovens, dryers, etc. Note that in FIGS. 1-6, identical or similar parts are indicated by identical reference numerals.

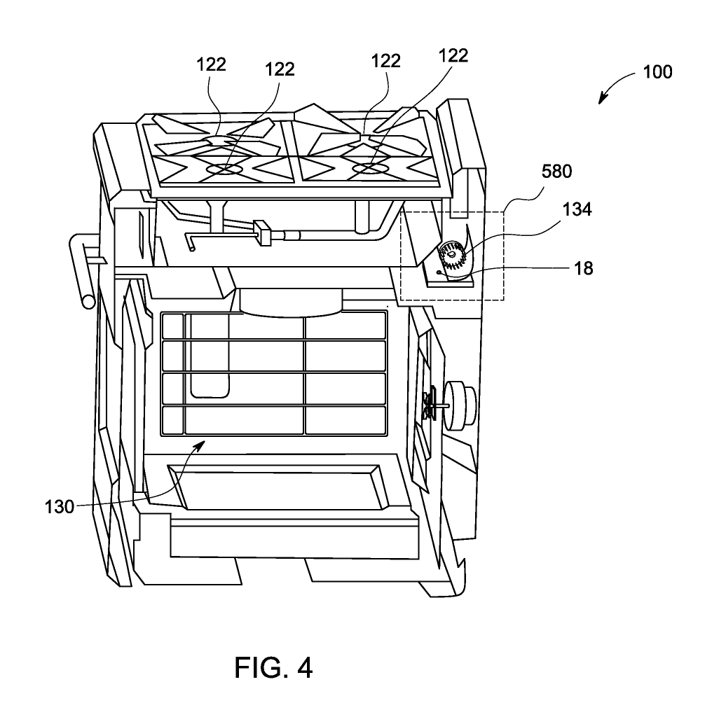

The appliance 100 depicted in FIG. 1 generally includes an outer body or housing 112 that has a generally rectangular shaped cook top 114. An oven 115, not shown in detail, is positioned below the cook top 114 and generally includes a front-opening access door 116 for closing the oven cavity. An integral backsplash 118 extends upward from a rear edge 120 of the cook top 114 and comprises various controls 121 for selectively operating heating elements such as one or more gas burners 122 located on the cook top 114 and heating elements (not shown in FIG. 1, but indicated in FIG. 2) in the oven 115. In the configuration depicted in FIG. 1, four gas burners 122 are shown with respect to the cook top 114. As best seen in FIG. 4, appliance 100 includes a cooling fan 134 to circulate cooling air through the interior of appliance 100 between the external housing and the oven cavity to avoid overheating of the controls and the exterior surfaces of the appliance from heat generated in the oven cavity by the oven heating elements.

FIG. 2 illustrates a circuit diagram depicting an embodiment of a power control system 301 for the electric heating elements of appliance 100 that includes a watchdog circuit 10 for protecting appliance 100 from overheating in the event cooling fan 134 fails to operate properly. Heat for the oven cavity is provided by broil element 52, bake element 54 and convection heating element 56. Broil element 52 is selectively electrically connected to power supply input L1 through the normally open contacts of switch 62. Bake element 54 is selectively electrically connected to power supply input L1 through the normally open contacts of switch 64 and normally closed contacts of switch 62. Convection element 56 is connected to power supply input L1 through normally open contacts of switch 66, normally closed contacts of switches 64 and 62.

By this arrangement only one of these heating elements can be connected to L1 at a time, thereby limiting the maximum power load of the appliance. Switches 58-62 may be manually controlled electromechanical switches, or electrically controlled by an electronic controller in response to manual inputs or timer inputs. Each of elements 52-56 are electrically connected to power supply line L2 through relay device 42 comprising relay switch 66 and relay coil 68. Each of the heating elements is connected to the common contact of switch 66. The normally closed contacts of switch 66 provide the open state for switch 66.

Normally open contacts of switch 66 are connected to L2 via thermal switch 65. The switching state of relay device 42 is controlled by watchdog circuit 10. As will be hereinafter described, when the fan 134 is operating normally, the output from circuit 10 energizes coil 68, which switches switch 66 to the closed state in which the oven heating elements are electrically connected to L2 via thermal switch 65, thereby enabling energization of the heating elements. When the fan 134 is not rotating at a sufficient speed, the output of circuit 10 de-energizes coil 68, which switches switch 66 to its open state de-coupling the heating elements from L2 thereby preventing energization of the heating elements.

The circuit 10 generally includes a damper capacitor 12, a damper reset circuit 14, and an enable circuit 16, which are electrically coupled to the output of a fan monitoring circuit comprising a magnetic reed switch 18. The enable circuit 16 comprises transistor 36, a biasing resistor 38 connected electrically between the emitter and the base of enable transistor 36 and resistor 40 connecting the base of transistor 36 to damper capacitor 12. The state of the charge on capacitor 12 which is connected between the base of transistor 36 and ground determines the state of transistor 36. The charging circuit for capacitor comprises power supply 28 and serially connected resistors 38 and 40. The discharge circuit comprises resistor 22 and transistor 32. The capacitor 12 is connected electrically to the resistor 22 and resistor 40 at node B. The coil 68 of relay device 42 is electrically serially connected between the collector of transistor 36 and ground.

The damper reset circuit 14 is shown in FIG. 2 as generally including resistor 26, resistor 34 and transistor 32. The transistor 32 can function as a damper reset transistor and the resistor 34 can function as a biasing resistor. The resistor 34 is electrically connected between the base and emitter of transistor 32. That is, resistor 34 and resistor 26 are electrically connected to node A, which in turn is an electrical input to transistor 32. In general, the switching signal from the switching circuit is ac coupled to the base of transistor 32 via the differentiator circuit 20 comprising capacitor 24 and resistor 26, which are serially electrically connected between the output from switch 18 and the base of transistor 32. The circuit parameters for the damping capacitor 12 and resistors 38, 40 and 22 are selected such that when the switch rate is of switch 18 is at or above a predetermined rate capacitor 12 will be discharged through transistor 32 and resistor 22 faster than it is charged through resistors 38 and 40, thereby holding transistor 36 in its ON or conductive state enabling the energization of coil 68 by power supply 28. When the switching rate is less than the predetermined rate, capacitor 12 will discharge, switching transistor 36 to its OFF or non-conducting state, preventing energization of coil 68.

Although damper reset transistor 32 and enable transistor 36 are illustrated and described herein as transistors, it will be understood that damper reset transistor 32 and enable transistor 36 are not limited to transistors. Rather, damper reset transistor 32 and enable transistor 36 can be any electronic switch that includes a first position that allows electrical current to flow through the switch and a second position that prevents electrical current from flowing through the switch.

The electric switch 18 is actuated by a magnetic field of the magnet 19, mounted on a blade of the cooling fan 134. The electric switch 18 is located proximate to the path of the magnet 19, such that when the magnet 19 rotates past the electric switch 18, the electric switch 18 is actuated. More specifically, in the illustrative embodiment, switch 18 is a magnetic reed switch which is biased open. As the magnet passes sufficiently close to the switch for the magnetic field to overcome the bias, the switch closes and remains closed until the magnet moves far enough away from the switch that the field no longer is sufficient to overcome the bias. That is, the electric switch 18 closes and opens with each rotation of the rotary member generating a pulse train having a switching frequency corresponding to the rate of rotation of the rotary member, cooling fan 134. By selecting the aforementioned predetermined switching rate, to correspond to the minimum acceptable rate of rotation of the cooling fan 134, circuit 10 is operative to denergized coil 68 thereby preventing energization of the oven heating elements 52, 54, and/or 56 in the event of a failure of the cooling fan 134 to rotate at a speed sufficient to perform its cooling function.

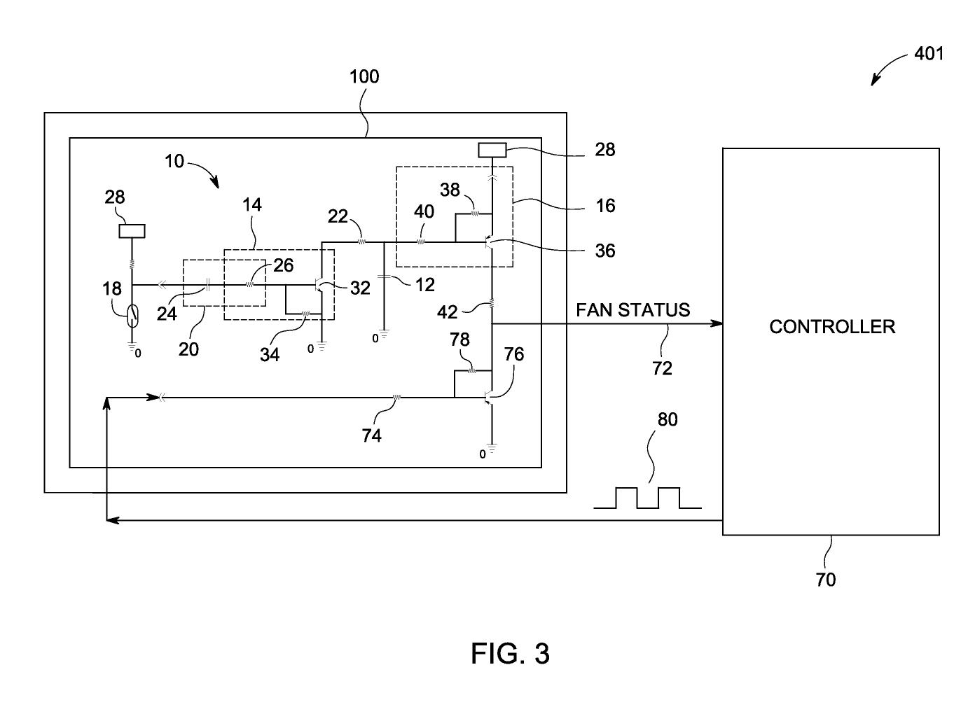

FIG. 3 illustrates a circuit diagram of a system 401 for monitoring an appliance, such as, for example, appliance 100, in accordance with an alternative embodiment. As indicated previously in FIGS. 1-6, identical or similar parts or elements are generally indicated by identical reference numerals. The configuration depicted in FIG. 3 represents a variation to the arrangement illustrated in FIG. 2.

In the system 401, the controller 70 monitors the fan status and is programmed to prevent energization of the heating elements when the fan status signal signifies a malfunction of the fan. In this embodiment, circuit 10 is substantially the same as in FIG. 3, except that the output of circuit 10 is monitored by the controller rather than being operative to directly enable and disable energization of the oven heating elements. More specifically, controller 70 generates a pulse train 80 that passes through a resistor 74 and interacts with the resistor 78 and a transistor 76. The resistor 74 is connected electrically to the base of transistor 76 and resistor 78 is connected between the base and emitter of transistor 76. A pull-up resistor 42 electrically connects the collector of transistor 76 to the collector of transistor 36 of circuit 10.

By this arrangement, when transistor 36 is in its ON state, the pulse train 80 is passed through to the fan status input 72, signifying to the controller that the fan is working properly. If transistor 36 is in its OFF state, the pulse train is not passed through to the fan status input 72, signifying to the controller that the fan is not rotating at a sufficient speed. The controller 70 is programmed to prevent energization of the heating elements when the pulse train is not present at input line 72. Note that the controller 70 can be, in some embodiments, an ERC (Electronic Ranger Controller) for controlling the appliance 100. Also, although the controller 70 can be depicted in FIG. 3 as being separate from appliance 100, it can be appreciated that the controller 70 can be preferably integrated with the appliance 100 and forms a part of the resulting manufactured appliance 100.

In general, when the switching frequency of the electric switch 18 exceeds an particular fixed threshold, an output of the circuit 10 can be enabled, and this output can be utilized to pass through a signal to indicate to a controller of the appliance 100 that the cooling fan 134 can be operating properly or enable a relay such as device 42 that can enable the heating elements 52, 54, and 56 directly. Note that the configuration depicted in FIG. 3 can be utilized individually or in association with the configuration depicted in FIG. 2, depending upon design considerations.

FIG. 4 illustrates a three-dimensional pictorial view of the appliance 100 depicted with respect to FIGS. 1-5 including the cooling fan 134 and the electric switch 18, in accordance with the disclosed embodiments. Thus, for example, the gas burners 122 are shown in FIG. 4 along with the interior chamber 130, but not all details are depicted for simplicity sake. A cutaway view 58 is shown in FIG. 4, which specifically identifies the cooling fan 134 and the electric switch 18 with respect to its position within the appliance 100.

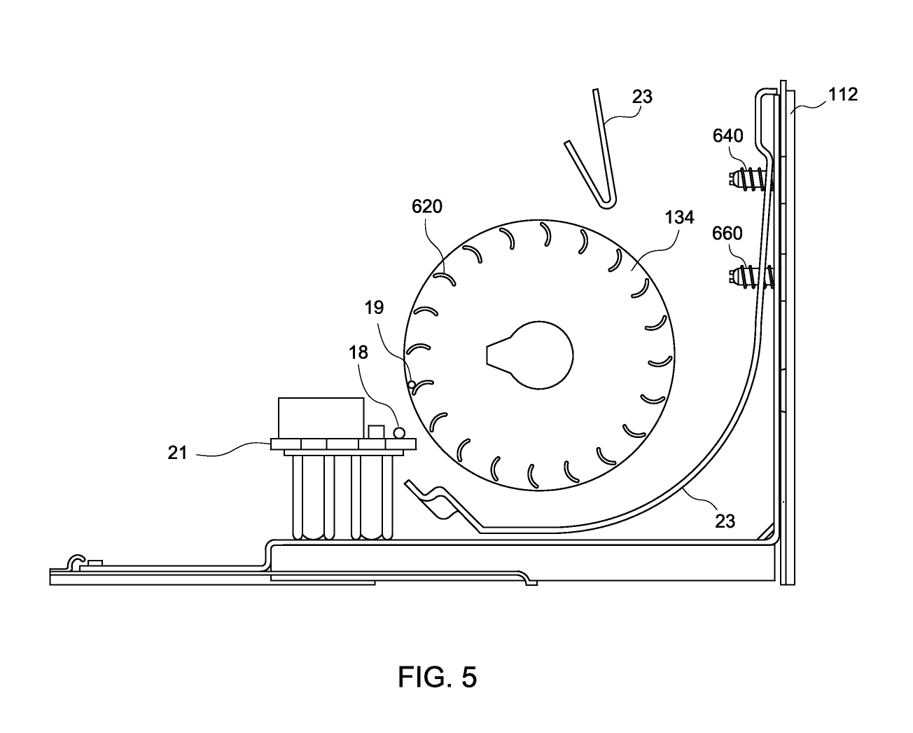

FIG. 5 illustrates a side view of the electric switch 18 and the cooling fan 134 depicted in FIG. 4, in accordance with the disclosed embodiments. The magnet 19 is shown in FIG. 5 with respect to the electric switch 18, which is in this embodiment is a reed switch. The electric switch 18 is connected electrically to a PCB (Printed Circuit Board) 21, which supports the electric switch 18. The magnet 19 is mounted to fan blade 62 of the cooling fan 134. A curved plate 23 partially surrounds the cooling fan 134 and extends the length of the fan in a direction generally parallel to the axis of rotation of the fan. The curved plate 23 directs airflow with respect to the cooling fan 134. The curved plate 23 is attached to the housing 112 by two screws or fasteners 64 and 66.

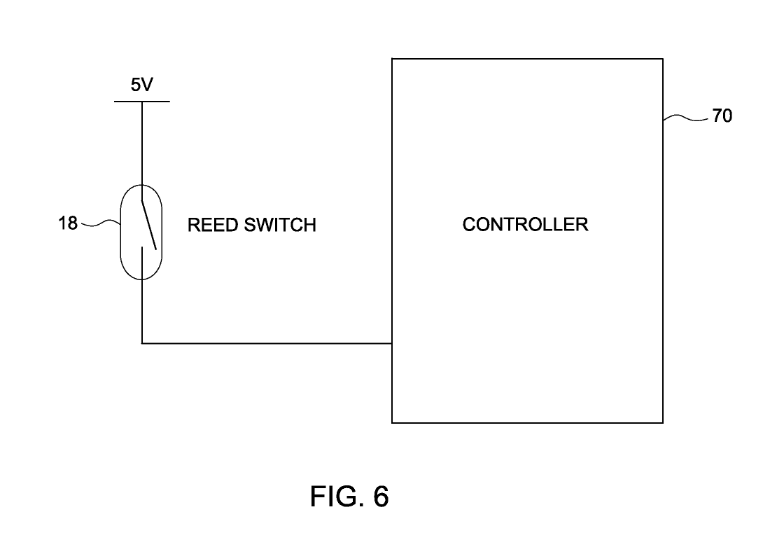

FIG. 6 illustrates a schematic diagram of an alternative arrangement of the reed switch 18 with respect to the controller 70. The arrangement depicted in FIG. 6 is similar to that disclosed in FIGS. 1-5 herein, the difference being that there is no watchdog circuit. In the configuration depicted in FIG. 6, the reed switch 18 can interface directly to the controller 70. In this arrangement the input to the controller 70 (i.e., an ERC) is the switching frequency of the reed switch 18, which correlates directly to the speed of the cooling fan 134. The configuration depicted in FIG. 6 can thus be adapted for use with the cooling fan 134, fan blade 62, and so forth, as indicated in the various implementations shown in FIGS. 1-5.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for monitoring a cooling fan having a rotary member and utilized in an appliance having a heating element, the system comprising:
an electric switch actuated by a magnetic field of a magnet mounted on the rotary member, the electric switch being located proximate to a path of the magnet such that the magnetic field of the magnet actuates the electric switch with each rotation of the magnet past the switch thereby causing the electric switch to switch at a switching frequency proportional to a rate of rotation of the rotary member; and
a circuit responsive to an electrical signal from the electric switch, wherein the circuit generates a signal indicative of a status of the cooling fan, based on the switching frequency of the electric switch.

2. The system of claim 1, further comprising a controller for controlling the appliance.

3. The system of claim 2, wherein the controller is responsive to the signal from the circuit in order to permit the controller to directly interface with the heating element of the appliance and disable the heating element in the event of the failure of the cooling fan.

4. The system of claim 1, further comprising a relay in electrical communication with the heating element, wherein the relay is responsive to the signal generated by the circuit to control the heating element.

5. The system of claim 1, wherein the circuit comprises a watchdog circuit.

6. The system of claim 1, wherein the electric switch comprises a reed switch.

7. The system of claim 2, wherein the controller comprises an electronic range controller for controlling the appliance.

8. A system for monitoring a cooling fan having at least one fan blade and utilized in an appliance having a heating element, the system comprising:
an electric switch actuated by a magnetic field of a magnet mounted on the at least one fan blade, the electric switch being located proximate to the magnet, wherein the magnet rotates past the electric switch to actuate the electric switch via the magnetic field at a switching frequency with each rotation of the at least one fan blade;
a circuit responsive to an electrical signal from the electric switch, wherein the circuit generates a signal indicative of a status of the cooling fan, based on the switching frequency of the electric switch; and
a controller for controlling the appliance, wherein the controller is responsive to the signal from the circuit in order to permit the controller to directly interface with the heating element of the appliance and disable the heating element in the event of the failure of the cooling fan.

9. The system of claim 8, further comprising a relay in electrical communication with the heating element, wherein the relay is responsive to the signal generated by the circuit to control the heating element.

10. The system of claim 8, wherein the circuit comprises a watchdog circuit.

11. The system of claim 8, wherein the electric switch comprises a reed switch.

12. The system of claim 8, wherein the controller comprises an electronic range controller for controlling the appliance.

13. The system of claim 8, wherein the appliance comprises a cooking range.

14. A system for monitoring a cooling fan having at least one fan blade and utilized in an appliance having a heating element, the system comprising:
a reed switch actuated by a magnetic field of a magnet mounted on the at least one fan blade, the reed switch being located proximate to a path of the magnet, wherein the magnet rotates past the reed switch to actuate the reed switch via the magnetic field at a switching frequency proportional to a rate of rotation of the at least one fan blade; and
a watchdog circuit responsive to an electrical signal from the reed switch, wherein the watchdog circuit generates a signal indicative of a status of the cooling fan, based on the switching frequency of the electric switch.

15. The system of claim 14, further comprising a controller for controlling the appliance.

16. The system of claim 15, wherein the controller is responsive to the signal from the watchdog circuit in order to permit the controller to directly interface with the heating element of the appliance and disable the heating element in the event of the failure of the cooling fan.

17. The system of claim 14, further comprising a relay in electrical communication with the heating element, wherein the relay is responsive to the signal generated by the watchdog circuit to control the heating element.

18. The system of claim 15, wherein the controller comprises an electronic range controller for controlling the appliance.

19. The system of claim 14, wherein the appliance comprises a cooking range.

20. The system of claim 14, wherein the cooling fan comprises a centrifugal cooling fan.
